(19) United States
(12) Patent Application Publication
(10) Pub. No.: US 2024/0267233 A1
(43) Pub. Date: Aug. 8, 2024

(54) TRUSTED NETWORK TO PREVENT REPLACEMENT AND CLONING ATTACKS

(71) Applicant: Micron Technology, Inc., Boise, ID (US)

(72) Inventor: Zhan Liu, Cupertino, CA (US)

(21) Appl. No.: 18/431,415

(22) Filed: Feb. 2, 2024

Related U.S. Application Data
(60) Provisional application No. 63/483,719, filed on Feb. 7, 2023.

(51) Int. Cl. H04L 9/32; H04L 9/08

(52) U.S. Cl. CPC H04L 9/3263; H04L 9/0877; H04L 9/3247

(57) ABSTRACT

In some aspects, the techniques described herein relate to a system including: a remote key management server (RKMS); and a computer network communicatively coupled to the RKMS, the computer network including: a first computing device a second computing device, and a local key management server (LKMS) communicatively coupled to the RKMS, the first computing device, and the second computing device, wherein the LKMS is configured to: writes a LKMS public key to the first computing device using a command signed by the RKMS, write a public key of the second computing device to the first computing device using a second command signed using a private key corresponding to the LKMS public key.

### RELATED APPLICATIONS

The present application claims priority to Prov. U.S. Pat. App. Ser. No. 63/483,719 filed Feb. 7, 2023, the entire disclosure of which application is hereby incorporated herein by reference.

### FIELD OF THE TECHNOLOGY

At least some embodiments disclosed herein relate generally to the security of computing systems and, in particular, utilizing a hierarchal key management system network to prevent network attacks.

### BACKGROUND

Computing systems are subject to various forms of attacks that compromise the security and integrity of these systems. One such attack is a replacement attack. In a replacement attack, a component (e.g., a persistent storage device or volatile memory device) is replaced with a malicious component that enables unauthorized access to the computing system. Another type of attack is a cloning attack. In this type of attack, the contents of a storage device are copied into a second storage device. This second storage device is then used to operate a copy of the computing system, allowing malicious users to access the cloned data via a cloned computing system. For example, in some scenarios, the contents of the storage device may include data representing the identity of the storage device (e.g., a unique identifier, etc.). If such a storage device (and the identity data) is cloned, a malicious can store any other malicious data and other devices that verify the storage device based on the identity data will trust the malicious data.

### BRIEF DESCRIPTION OF THE DRAWINGS

FIG. 1 is a block diagram illustrating a computer network according to some of the example embodiments.

FIG. 2 is a block diagram illustrating a computer network according to some of the example embodiments.

FIG. 3A is a flow diagram illustrating a method for replacing a KMS in a computer network according to some of the example embodiments.

FIG. 3B is a flow diagram illustrating a method for replacing a KMS public key on a local device according to some of the example embodiments.

FIG. 3C is a flow diagram illustrating a method for executing a signed command according to some of the example embodiments.

FIG. 4 is a flow diagram illustrating a method for distributing public keys in a computing network according to some of the example embodiments.

FIG. 5A is a flow diagram illustrating a method for verifying the identify of a receiving device according to some of the example embodiments.

FIG. 5B is a flow diagram illustrating a method for generating a verification response according to some of the example embodiments.

FIG. 6 is a block diagram illustrating a computing system according to some embodiments of the disclosure.

FIG. 7 is a block diagram of a computing device according to some embodiments of the disclosure.

### DETAILED DESCRIPTION

The example embodiments provide solutions for preventing attacks on computing systems and, in particular, to utilizing a hierarchal key management system network to prevent network attacks.

In a computer network, each device has an asymmetric key pair (e.g., public key and private key). In some implementations, these asymmetric key pairs may be generated using a physically unclonable function (PUF). Any given device's public key may be saved in other devices that the given device wishes to communicate with securely. The computer network can include a local server which acts as a key management server (KMS). This local KMS (LKMS) includes a private key that can be used to sign secure commands. One such secure command is a command to write a first device's public key to a second device.

During operation, when a first device initiates communications with a second device, the first device can read the second device's public key from its local storage and verify the second device using the local public key. For example, the first device can send a nonce to the second device. The second device can sign the nonce using its private key and return a signed value to the first device. The first device can then validate the second device by verifying the digital signature. Using this process, the first device can verify that the second device is valid and prevent cloning or replacement attacks.

In the various embodiments, the LKMS can be used to improve the performance by allowing a remote KMS (RKMS) to authorize the LKMS to manage devices in the computer network. Further, in some implementations, the computer network can include a hierarchy of both devices and lower-level KMSs which enable faster key operations.

The following description uses the example of an automobile network which can include multiple subsystems managed by one or more LKMSs. However, the disclosure is not limited as such. For example, the example embodiments may also be used in other types of networks such as cellular networks. In such an embodiment, the devices may be mobile phones subject to cloning of identifying data (e.g., International Mobile Equipment Identity, IMEI, numbers) or sensor networks subject to replacement attacks with malicious sensors.

Currently, most attempts to prevent replacement and cloning attacks in networks involve the use of transport layer security (TLS) to establish a trusted connection between a remote server and one or more local devices. Such an approach is a generalized approach and suffers from numerous deficiencies. For example, using TLS is time-consuming given the connection setup and teardown procedure. Further, it relies on an external network connection which may not be possible in many network (e.g., automobile, sensor, etc.). As such, there exists a need for a faster and offline-capable method for validating network devices. The example embodiments solve these technical problems.

In some aspects, the techniques described herein relate to a system including: a remote key management server (RKMS); and a computer network communicatively coupled to the RKMS, the computer network including: a first computing device, a second computing device, and a local key management server (LKMS) communicatively coupled to the RKMS, the first computing device, and the second computing device, wherein the LKMS is configured to: write a LKMS public key to the first computing device using a first command signed by the RKMS, and write a public key of the second computing device to the first computing device using a second command signed using a private key corresponding to the LKMS public key.

In some aspects, the techniques described herein relate to a system, wherein the LKMS is further configured to request a command from the RKMS and receive the first command from the RKMS, wherein the first command is signed using an RKMS private key.

In some aspects, the techniques described herein relate to a system, wherein the first computing device is configured to receive the first command and validate the first command by validating a digital signature using an RKMS public key corresponding to the RKMS private key.

In some aspects, the techniques described herein relate to a system, wherein the first computing device replaces the RKMS public key with the LKMS public key if the digital signature is valid.

In some aspects, the techniques described herein relate to a system, wherein the LKMS is configured to receive the public key of the second computing device, confirm an identity of the second computing device, and transmit the second command to the first computing device, the second command including the public key of the second computing device.

In some aspects, the techniques described herein relate to a system, wherein the first computing device is configured to validate the second command by validating a digital signature using the LKMS public key.

In some aspects, the techniques described herein relate to a system, wherein the first computing device is further configured to transmit a nonce to the second computing device, receive a response including a digital signature generated by the second computing device, validate the digital signature generated by the second computing device using the public key of the second computing device, and initiate communications with the second computing device when the digital signature is valid.

In some aspects, the techniques described herein relate to a system, wherein the second computing device is configured to receive the nonce and generate the digital signature by signing the nonce and a unique identifier (UID) of the second computing device using a private key of the second computing device, the private key corresponding to the public key of the second computing device stored by the first computing device.

In some aspects, the techniques described herein relate to a method including: receiving, by a computing device, a first public key from a local key management server (LKMS); receiving, by the computing device, a signed command, the signed command including a second public key associated with a second computing device; validating, by the computing device, the signed command using the first public key; and writing the second public key to a secure storage area of the computing device.

In some aspects, the techniques described herein relate to a method, wherein receiving the first public key includes receiving a second signed command, the second signed command signed using a remote key management server (RKMS) private key.

In some aspects, the techniques described herein relate to a method, further including validating the second signed command using an RKMS public key corresponding to the RKMS private key and replacing the RKMS public key with the first public key.

In some aspects, the techniques described herein relate to a method, wherein receiving the signed command includes receiving the second public key and a digital signature and wherein validating the signed command includes validating the digital signature using the first public key.

In some aspects, the techniques described herein relate to a method, further including generating a nonce and transmitting the nonce to the second computing device before initiating a connection to the second computing device.

In some aspects, the techniques described herein relate to a method, further including receiving a response to the nonce, the response including a second digital signature and validating the second digital signature using the second public key before initiating a connection to the second computing device.

In some aspects, the techniques described herein relate to a method including: generating, by a first computing device, a nonce; transmitting, by the first computing device, the nonce to a second computing device; receiving, by the first computing device, a response from the second computing device, the response including a digital signature generated using the nonce; reading, by the first computing device, a public key associated with the second computing device and stored in a local storage area; and validating, by the first computing device, the second computing device by validating the digital signature using the public key.

In some aspects, the techniques described herein relate to a method, wherein generating nonce includes generating a random or pseudo-random value.

In some aspects, the techniques described herein relate to a method, further including transmitting data to the second computing device after validating the second computing device.

In some aspects, the techniques described herein relate to a method, wherein the response further includes a received nonce and validating the second computing device further includes comparing the received nonce to the nonce.

In some aspects, the techniques described herein relate to a method, wherein the response further includes a unique identifier (UID) of the second computing device and validating the second computing device further includes comparing the UID to a local UID mapped to the public key.

In some aspects, the techniques described herein relate to a method, wherein reading the public key includes reading the public key from a secure storage area of a secure element.

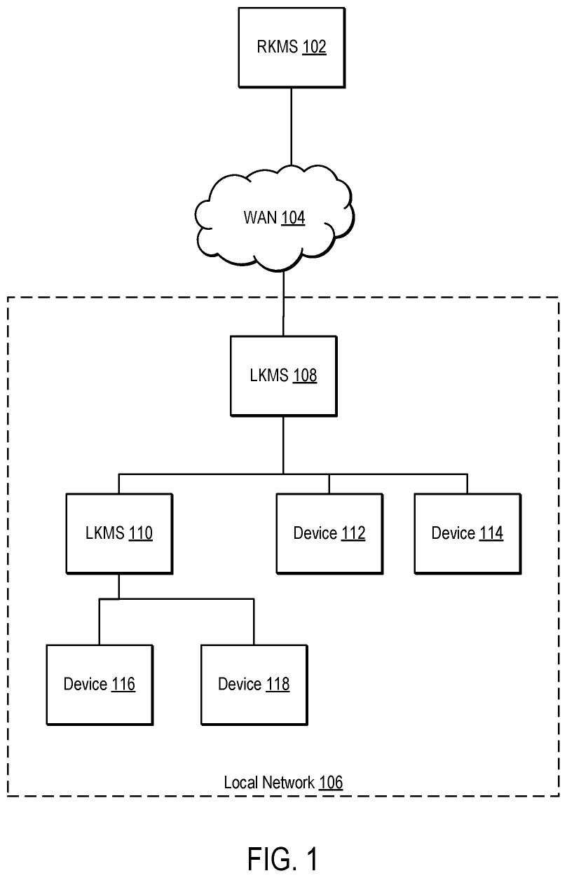

FIG. 1 is a block diagram illustrating a computer network according to some of the example embodiments.

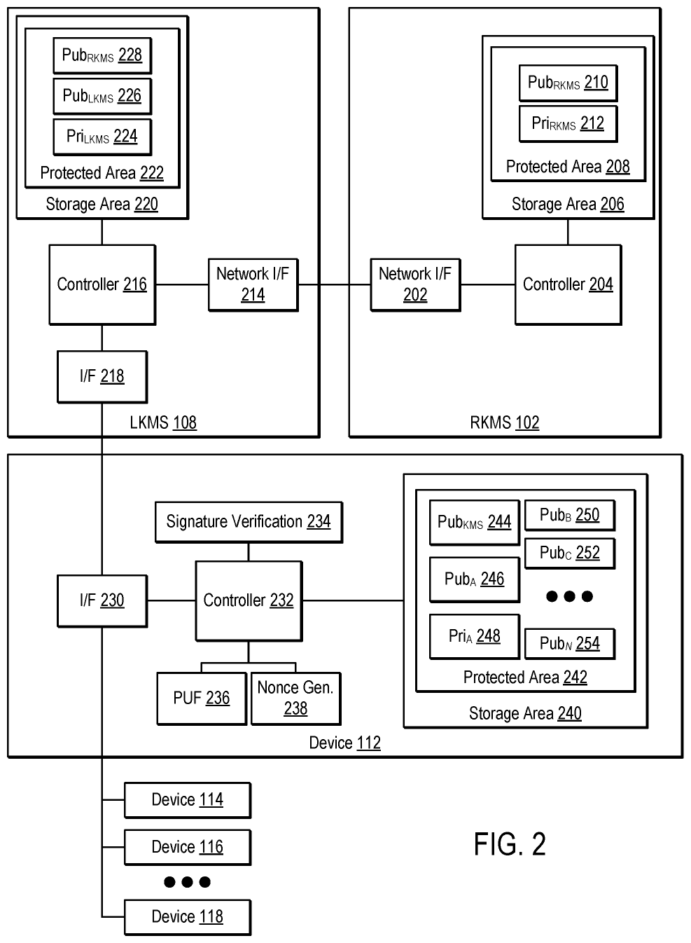

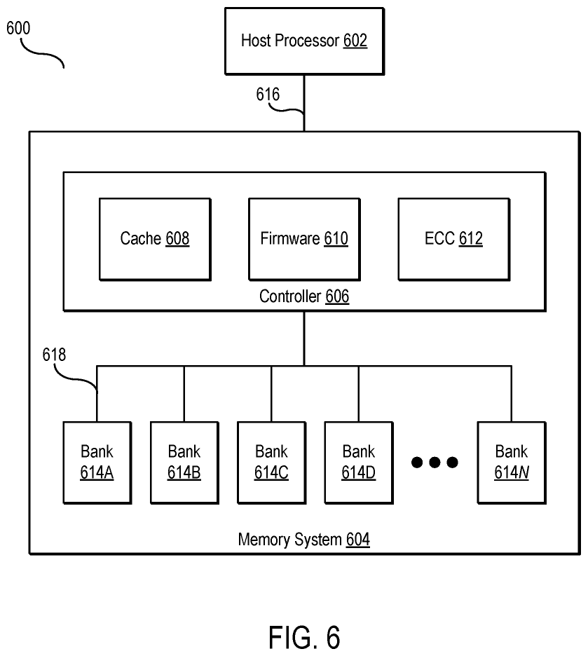

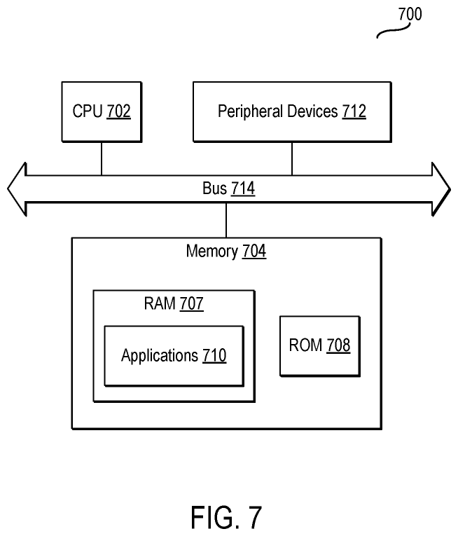

The illustrated network includes an RKMS 102 communicatively coupled to a local network 106 via a wide area network (WAN 104), such as the Internet. The local network 106 includes various computing devices including, without limitation, LKMS 108, LKMS 110, device 112, device 114, device 116, and device 118. Each of the devices and KMSs may be implemented as one or more computing devices such as that depicted in FIG. 7. Further, some or all of the device may include persistent storage devices such as that depicted in FIG. 6. Specific components of the devices are provided in FIG. 2 and reference is made to that description for further detail on internal components of the devices.

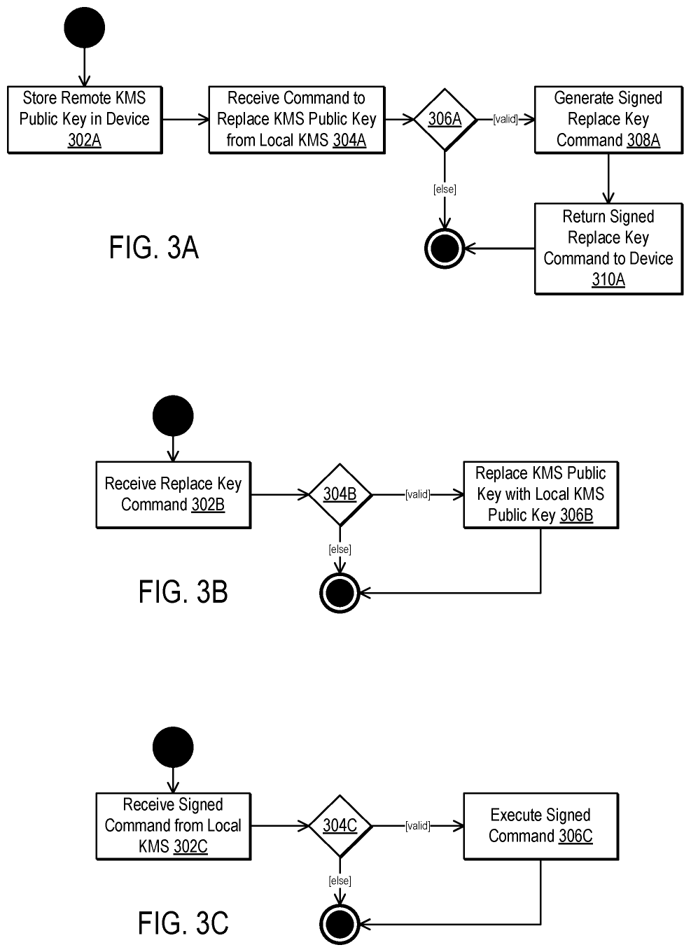

In some implementations, RKMS 102 can comprise a remote key management server that can manage keys for remote computing devices. As such, RKMS 102 includes a network interface allowing for network connections via WAN 104. RKMS 102 may manage multiple local networks including local network 106 as well as multiple other devices not illustrated in FIG. 1. Generally, the RKMS 102 may sign commands on behalf of other devices after authenticating the devices. Details of this procedure are provided in the description of FIG. 3A.

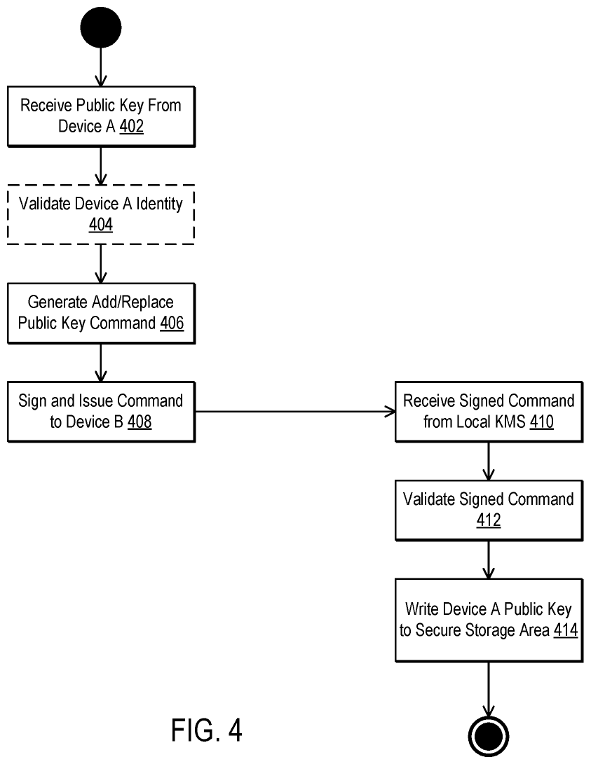

Local network 106 includes various LKMS devices (e.g., LKMS 108 and LKMS 110, although the network is not limited to two). In the various implementations, these LKMSs operate as local key management servers and perform similar functions to RKMS 102. Notably, the LKMS can issue a request to the RKMS to change the KMS public keys of the various devices. Then, the LKMSs can issue signed commands to the devices to write other public keys to the devices. Details of this process are provided in FIGS. 3B and 3C as well as FIG. 4, which are not repeated herein.

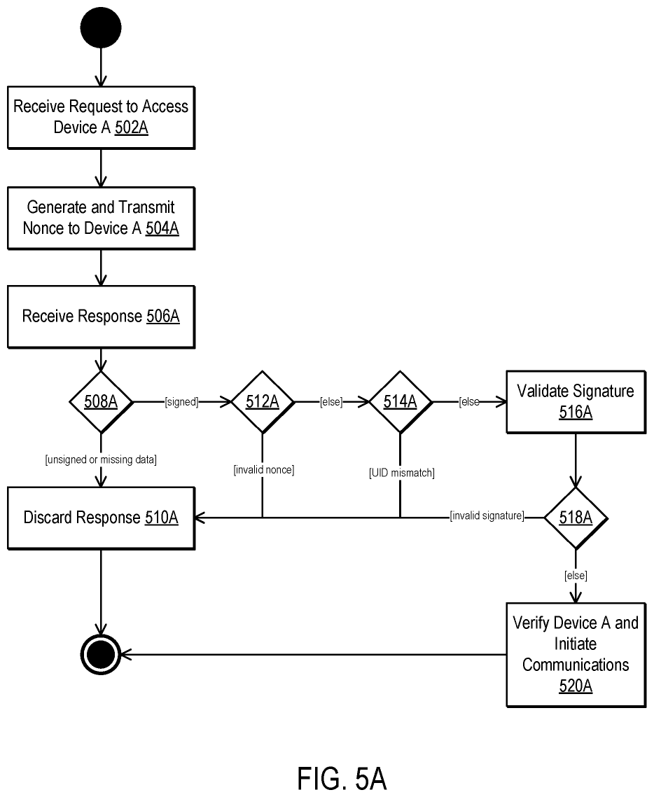

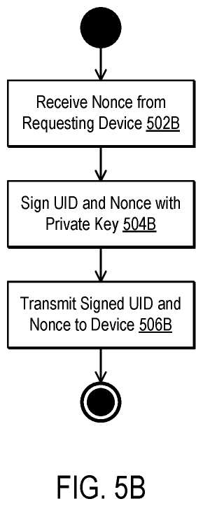

The various local devices can communicate amongst themselves. During these communications, a sender of data can validate the identity of the receiver by issuing a challenge to the receiving device and validating a returned signature using a locally stored public key. The LKMS may distribute public keys in a secure manner such that each device can trust other devices if the signature validations pass. Details of this process are provided in FIGS. 5A and 5B which are not repeated herein.

As illustrated, the devices of local network 106 may arranged hierarchically. That is, LKMS 108 may be capable of managing LKMS 110, device 112, and device 114 while LKMS 110 may be capable of managing only device 116 and device 118. In some implementations, LKMS 108 may not be capable of managing device 116 and device 118 (ceding control to LKMS 110). In other embodiments, control may be passed through (e.g., both LKMS 108 and LKMS 110 may control device 116 and device 118).

In some implementations, the key update procedures may be performed bottom-up. For example, on first boot, all devices in local network 106 may store the public key of RKMS 102. First, LKMS 110 may issue a request to receive a signed command to update the KMS public keys of device 116 and device 118. LKMS 110 may then update the KMS public keys of these devices. Next, LKMS 108 may perform a similar process and update the KMS public keys of LKMS 110, device 112, and device 114. In this manner, all KMS public keys may be updated throughout the network on startup while ensuring that each device obtains the “nearest” LKMS public key in the hierarchy.

FIG. 2 is a block diagram illustrating a computer network according to some of the example embodiments.

In the illustrated network, RKMS 102, LKMS 108, device 112, device 114, device 116, and device 118 are illustrated. Reference is made to FIG. 1 which describes general aspects of these devices.

In an implementation, RKMS 102 includes a controller 204, interface 202, and a storage area 206. In some implementations, controller 204 and storage area 206 (and optionally interface 202) may be implemented in a secure element (SE). Examples of a secure element include a Secure Enclave, a Hardware Security Module (HSM), a Trusted Execution Environment (TEE), a Trusted Platform Module (TPM), Secure Element in the Cloud (SEiC), or similar type of secure processing device. As illustrated, the storage area 206 can include a protected region 208 (e.g., a write-protected region) that stores cryptographic data including the RKMS public key 210 and RKMS private key 212. In some implementations, these keys can be generated via a PUF (not illustrated). In some implementations, RKMS 102 may also store public keys of other LKMS devices (including LKMS 108).

In an implementation, LKMS 108 similarly includes a network interface 214, controller 216, local interface 218, and storage area 220. As with RKMS 102, the storage area 220, controller 216 and the interface may be part of an SE. Network interface 214 allows LKMS 108 to communicate with RKMS 102 to, among other things, request and receive signed commands as described in FIGS. 3A and 3B. Local interface 218 allows the LKMS 108 to communicate with local network device including device 112. The LKMS 108 may use this interface to write public keys to various devices as described in FIG. 3C and FIG. 4. As illustrated, the storage area 220 can include a protected area 222 (e.g., a write-protected region) that stores cryptographic data including the LKMS's own asymmetric key pair (LKMS public key 226, LKMS private key 224) as well as the public key of the RKMS 102 (RKMS public key 228). By storing RKMS public key 228, the LKMS 108 can validate commands received from the RKMS 102.

Device 112 includes a controller 232, interface 230, signature verification module 234, nonce generator 238, PUF 236, and a storage area 240. Some of all of these components may be included in an SE. In some implementations, the controller 232 can comprise any type of microprocessor or controller capable of executing computer-readable program instructions and may be configured to perform any and all of the method steps described herein. In some implementations, the controller 232 may be capable of receiving public keys from LKMS 108 and storing these public keys in protected area 242 of storage area 240. As illustrated, protected area 242 stores public keys 250, 252, and 254 corresponding to devices 114, 116, and 118, respectively, however the disclosure is not limited as such. Protected area 242 may also store an asymmetric key pair (public key 246 and private key 248) generated by PUF 236. In the illustrated embodiment, the PUF 236 may comprise a physical hardware circuit that exploits inherent randomness introduced during manufacturing to give a physical entity a unique ‘fingerprint’ or trust anchor. In the illustrated embodiment, the PUF 236 produces a consistent and repeatable value. In some embodiments, the PUF 236 may comprise a static random-access memory (SRAM) PUF, Delay PUF, or any other PUF technology. In some implementations, protected area 242 can also include a KMS public key 244. In some implementations, KMS public key 244 may initial correspond to RKMS public key 210 but may be changed to LKMS public key 226 using the process of FIGS. 3A and 3B.

The device 112 may write these public keys in response to a command from LKMS 108 using the process of FIG. 4.

In some implementations, controller 232 is configured to receive a nonce from nonce generator 238. In some implementations, the nonce can comprise a random or pseudo-random value. In some implementations, the SE can use a hardware random number generator (HRNG) which may be a physical device that generates truly random numbers by measuring natural phenomena such as electronic noise. Alternatively, or in conjunction with the foregoing, the SE can use a pseudorandom number generator (PRNG). A PRNG is a software-based algorithm that generates a sequence of numbers that appears to be random but are not truly random. PRNGs are typically seeded with an initial value, such as the current time or a hardware sensor reading, to ensure that the generated numbers are unique. In some implementations, a combination of an HRNG and PRNG may be used (e.g., using the HRNG to seed a PRNG). In alternative implementations, a monotonic counter or similar mechanism may be used to generate a nonce. In some implementations, a timestamp (which is not random, but may be sufficiently unique) may be used as a nonce. The controller 232 can transmit the nonce to another device (e.g., device 114, device 116, device 118) and receive a response. The controller 232 can forward the response to signature verification module 234, which validates the signature (and other aspects of the response). Based on this verification, controller 232 may allow or deny communications with the responding device. Details of this process are described in FIG. 5A which is not repeated herein.

Controller 232 may further be capable of receiving nonces generated by other devices. Indeed, each of device 114, device 116, and device 118 may include the same or similar components as device 112 and may generate and transmit nonces to device 112. In response, controller 232 may sign the nonce and return a digital signature (and optional copy of the nonce and UID) to the requesting device which may perform its own verification of the signature.

FIG. 3A is a flow diagram illustrating a method for replacing a KMS in a computer network according to some of the example embodiments. In the description below, the method of FIG. 3A can be performed by an RKMS.

In step 302A, the method can include storing an RKMS public key in a device on a network.

As described above, the device may be any type of computing device. In some implementations, during the manufacturing of this device, the RKMS public key may be written to an SE or similar secure part of the device. In some implementations, the RKMS public key may be written to a secure storage area such as a write-protected region of persistent storage (e.g., Flash storage) of the device. In some implementations, this secure storage area may be part of the SE or may be a dedicated storage device. In some implementations, the device may be a part of a larger subsystem. For example, the device may comprise a solid-state drive (SSD) or other storage device installed within a computing subsystem. As such, in these embodiments, the functions of the subsystem can be deployed independently of the security functions described herein.

In step 304A, the method can include receiving a command to replace the current RKMS public key from an LKMS.

In some implementations, the LMKS can comprise a server or other computing device on the computer network local to the device described above. In some implementations, the LKMS may be registered with the RKMS such that the RKMS can validate the identity of the LKMS. For example, the LKMS may include an asymmetric key pair (generated, for example, by a PUF) and the public key portion of the LKMS asymmetric key pair may be stored by the RKMS. As one example, during manufacturing the LKMS public key may be saved or otherwise provided to the RKMS before the LKMS is released from manufacturing. Alternatively, or in conjunction with the foregoing, the public key of the LKMS may be provided to the RKMS using a handshake procedure. In this procedure, the RKMS may have the current public key of the LKMS and the corresponding private key of the LKMS may be used to sign a request to change the keys of the LKMS (which can be validated by the RKMS).

In step 304A, the RKMS can receive a command signed using the current private key of the LKMS. This command may include the public key. In response, the RKMS can validate the signed command using the currently stored public key of the LKMS in step 306A. If the signature is valid, the RKMS can confirm that the LKMS is known and valid. As such, in response the RKMS can generate a command to replace a public key on a local device in step 308A and sign this command using its own private key. The RKMS can then return the signed command to the LKMS in step 310A. As will be described in FIG. 3B, since the local devices initially include the RKMS public key, the devices can validate this command. If, on the other hand, the RKMS cannot validate the signature in step 306A, the method can terminate and not return a signed command.

In the foregoing embodiments, the LKMS may also provide a unique identifier (UID) or similar type of authentication credential. In such a scenario, the RKMS may further confirm that the received public key is associated with the received UID. In such a scenario, the RKMS may maintain a mapping of UIDs to public keys.

FIG. 3B is a flow diagram illustrating a method for replacing a KMS public key on a local device according to some of the example embodiments. In some implementations, the method of FIG. 3B may be performed by a local device on a computer network.

In step 302B, the method can include receiving a signed replace key command.

In some implementations, the signed replace key command may be transmitted by an LKMS. In some implementations, the signed replace key command may be generated by an RKMS using the method of FIG. 3A. In some implementations, the signed replace key command may be receive upon a first booting of devices on a computer network. In some implementations, the signed replace key command can be issued over a local area network, local bus, or similar communications path.

In step 304B, the method can include validating the signed replace key command.

In some implementations, the local device can include a secure storage area that can be used to store public keys. In some implementations, this secure storage area can be part of an SE or similar type of secure computing device. In some implementations, this secure storage area can be a write-protected region of persistent memory. In some implementations, this secure storage area can store public keys of other devices. In some implementations, these public keys can include the public key of a KMS (e.g., RKMS). In some implementations, the local device can read the KMS public key (e.g., RKMS public key) and can use this KMS public key to validate the signed replace key command. If the validation fails, the method can end. If, however, the signed replace key command is valid, the method can proceed to step 306B.

In step 306B, the method can include replacing a KMS public key with an LKMS public key.

In the illustrated embodiment, the current KMS public key corresponds to the RKMS public key. In such a scenario, the local device stores the KMS public key written during manufacturing. The command received in step 302B may include the public key of the LKMS and the command is signed using the private key corresponding to the currently stored public key of the RKMS. After the local device validates the command to confirm that the RKMS actually authorized the transfer, the local device can replace its RKMS public key with the LKMS public key. Thus, effectively, the local device cedes control of signed commands to the LKMS by virtue of using the public key of the LKMS.

In some implementations, the foregoing methods of FIGS. 3A and 3B may be executed when an LKMS is first capable of communicating with the RKMS. For example, if the LKMS is installed within an automobile network, the LKMS may initiate, and the RKMS may perform, the methods upon first boot to authorize the LKMS to issue signed commands. If multiple LKMSs are in a network, this process may be completed for each LKMS. However, if the LKMSs are hierarchal, the process may be local to the sub-trec of the hierarchy. For example, LKMS 110 may issue a request to the RKMS using its own public key and the issue a command to device 116 and device 118 to replace its KMS public key with its own public key. Thus, LKMS 110 may be capable of controlling device 116 and device 118 while LKMS 108 may not.

FIG. 3C is a flow diagram illustrating a method for executing a signed command according to some of the example embodiments. In some implementations, the method of FIG. 3B may be performed by a local device on a computer network.

In step 302C, the method can include receiving a signed command from the LKMS. In some implementations, the signed command can include any type of command executable by the receiving device and no limit is placed on the operations performed in response to the command. As will be discussed, in some implementations, this command can include a command to write data to a secure area of the local device. Specifically, in some scenarios, this command can include a public key to write to the secure area.

In step 304C, the method can include validating the signed command. In some implementations, the local device can load the current KMS public key. As discussed, this KMS public key may initially correspond to the RKMS public key but may be changed to a LKMS public key using the process of FIGS. 3A and 3B. As such, the public key read in step 304C may correspond to the current LKMS in the computer network. The local device may use this KMS public key to verify the signature of the signed command. If the signature validation fails, the method may end. Alternatively, if the received signature is valid (i.e., is signed by the expected LKMS private key), the method may proceed to step 306C.

In step 306C, the method can include executing the signed command. As discussed above, no limit is placed on the format of the signed command or the operations performed. However, one type of command described and used in more detail herein is a command to write a public key to secure area of the local device. This type of command will generally include a public key of another computing device on the computer network. Further, the command may also include a UID, media access control (MAC) address, Internet Protocol (IP) address, or other identifier of the computing device. In response, the local computing device may issue a command to an SE or similar device to write the received public key to the secure area of the local device. In some implementations, the local device an also update a mapping of UID values to public key values to enable lookup when establishing communications with a device.

FIG. 4 is a flow diagram illustrating a method for distributing public keys in a computing network according to some of the example embodiments. In some implementations, step 402 through step 408 may be performed by an LKMS while step 410 through 414 may be performed by a local device.

In step 402, the method can include receiving a public key from a first device (Device A).

As discussed, the public key may comprise a public key portion of an asymmetric key pair. In some implementations, various asymmetric key algorithms may be used as Elliptic Curve Digital Signature Algorithm (ECDSA), Rivest-Shamir-Adleman (RSA), etc. In some implementations, the LKMS may receive the public key in response to a request for a public key issued by the LKMS to Device A. In other scenarios, Device A may issue its public key when joining the network.

In step 404, the method can include validating the identify of Device A.

In some implementations, the asymmetric key pair can be generated using a PUF and may be a unique identifier of Device A. When first joining a network, the LKMS may store a UID of Device A along with its public key. Then, if Device A attempts to rejoin the network (e.g., on restart), the LKMS can query this mapping to validate the public key. In this manner, Device A cannot be replaced when the network is not powered on since it will not be capable of generating the same public key (even if it can spoof the UID). As such, the LKMS can proactively allow or disallow devices from submitting their public keys using this step.

In step 406, the method can include generating a replace (or add) key public key command. In general, this command will include the received public key and an identity of Device A (e.g., a UID or similar value). The specific form of the command is not limiting.

In step 408, the method can include signing the command and issuing the command to Device B.

In some implementations, the LKMS can sign the command using its private key. In some implementations, this private key corresponds to a KMS public key written to Device B (using the process of FIGS. 3A through 3C). Although one device (Device B) is illustrated, the method can transmit the signed command to multiple such devices. For example, the LKMS may broadcast the signed command to all devices that the LKMS manages.

In step 410, the method can include Device B receiving the signed command from the LKMS. As discussed, the local device may include an interface to receive such commands over a local area network, bus, etc.

In step 412, the method can include validating the signed command. In some implementations, the local device can load the current KMS public key stored by the local device and can validate the signature using a digital signature algorithm (e.g., ECDSA, RSA, etc.). If the validation fails, the local device will ignore the command and not write the received public key to its secure storage area. Further, in some implementations, the local device may query the secure storage area and purge an existing key for Device A (e.g., by using the received UID). If, however, the digital signature validation passes, the method may proceed to step 414.

In step 414, the method can include writing the received public key to a secure storage area.

In some implementations, this secure storage area may comprise a write-protected region of an SE or similar type of device. In some implementations, the local device may store a mapping of the UID included in the command with the public key included in the command. Although a single device (Device A) is illustrated, the receiving device may execute step 410 through step 414 for each device managed by the LKMS.

In some implementations, the distributions of public keys can be performed across LKMSs. For example, device 116 may store the public key of device 112 despite the devices being managed by different LKMSs. In this scenario, LKMS 108 would receive and validate the public key of device 112. LKMS 108 would then sign a command to write the public key of device 112 to LKMS 110. LKMS 110 would validate this command using the public key of LKMS 108 stored using the procedure of FIGS. 3A through 3C. If validate, the LKMS 110 can generate its own command to write the public key of device 112 to device 116 and device 118. In this manner, public keys of all devices can be mediated through LKMSs throughout the network.

FIG. 5A is a flow diagram illustrating a method for verifying the identify of a receiving device according to some of the example embodiments. In some implementations, the method of FIG. 5A may be executed by a local device in a computer network

In step 502A, the method can include a request to access a receiving device (Device A). In some implementations, the request can be executed as part of the operations of the local device and the circumstances giving rise to the request are not limiting. In some implementations, the request will include an identity of Device A (e.g., UID, MAC address, IP address, etc.).

In step 504A, the method can include generating and transmitting a nonce to Device A.

In some implementations, the nonce can comprise a random or pseudo-random value. In some implementations, the SE can use a hardware random number generator (HRNG) which may be a physical device that generates truly random numbers by measuring natural phenomena such as electronic noise. Alternatively, or in conjunction with the foregoing, the SE can use a pseudorandom number generator (PRNG). A PRNG is a software-based algorithm that generates a sequence of numbers that appears to be random but are not truly random. PRNGs are typically seeded with an initial value, such as the current time or a hardware sensor reading, to ensure that the generated numbers are unique. In some implementations, a combination of an HRNG and PRNG may be used (e.g., using the HRNG to seed a PRNG). In alternative implementations, a monotonic counter or similar mechanism may be used to generate a nonce. In some implementations, a timestamp (which is not random, but may be sufficiently unique) may be used as a nonce.

In step 506A, the method can include receiving a response from Device A. As will be discussed, the transmitting device will expect to received a signed copy of the nonce and will performed various validations to confirm this expectation.

First, in step 508A, the method can include determining if the response includes a digital signature and includes the expected payload format. If the response does not include a valid digital signature, the method will discard the response in step 510A. Further, in some implementations, step 510A can include purging the public key of the device from a list of trusted public keys, as described in FIG. 4. If the digital signature is not included, the method can presume that Device A is compromised (e.g., by malicious software). Further, as illustrated, if the response does not include the expected payload (described herein), the method may discard the response for similar reasons.

Second, in step 512A, the method can include confirming that a nonce included in the response matches the nonce generated in step 504A. In some implementations, this may comprise determining if the nonces match. Such a step can prevent replay attacks and ensure that Device A is not repeating past responses in an attempt to spoof its identity. As discussed, the nonce may form part of the payload expected and verified in step 508A. If the received nonce does not match the nonce generated in step 504A, the method will discard the response in step 510A.

Third, in step 514A, the method can include determining if a received UID matches the expected UID. In some implementations, the method can query a table that maps UIDs to public keys. When receiving the request in step 502A, the method can identify the proper UID and compare the UID received in step 506A to this expected UID. If the UIDs do not match, the method discards the response in step 510A since the identity of Device A is not as expected (e.g., due to a replacement attack). As discussed, the UID may form part of the payload expected and verified in step 508A.

Finally, in step 516A, the method can include validating the digital signature included in the response. In some implementations, the digital signature can be generated by using the nonce as a message input into a digital signature algorithm (e.g., ECDSA, RSA, etc.) and using Device A's private key (corresponding to the public key held by the method) as the signing key. Alternatively, or in conjunction with the foregoing, the UID can be included with the nonce as the message (e.g., by concatenating the values). The method can use the same digital signature algorithm (e.g., ECDSA, RSA, etc.) to validate the received signature and confirm that Device A holds the private key corresponding to the public key held by the method. If this validation fails, the method can discard the response in step 510A.

Alternatively, if the validation passes, the method can verify Device A and initiate communications with Device A in step 518A. As illustrated, after verifying Device A's identity, the method may transmit data to Device B to perform any non-limiting operations between the method and Device A in step 520A. In some implementations, the method may periodically be executed to continue to verify Device

A. In some implementations, communications between the devices may be encrypted using the public key of Device A to ensure the identity of Device A. Generally, no limit is placed on the types of communications between the devices after Device A is verified using the above process.

FIG. 5B is a flow diagram illustrating a method for generating a verification response according to some of the example embodiments. The method of FIG. 5B may be performed by Device A, as referenced in the description of FIG. 5A.

In step 502B, the method can include receiving a nonce from a requesting device. In some implementations, step 502B may be performed in response to receiving a nonce from the requesting device (as discussed in step 504A). Generally, the nonce will comprise a random or pseudo-random value.

In step 504B, the method can include signing a nonce and (optionally) UID with a private key. In some implementations, a digital signature can be generated by using the nonce as a message input into a digital signature algorithm (e.g., ECDSA, RSA, etc.) and using a private key (corresponding to the public key held by the requesting device) as the signing key. Alternatively, or in conjunction with the foregoing, the UID can be included with the nonce as the message (e.g., by concatenating the values).

In step 506B, the method can include transmitting the signed nonce and (optional) UID to the requesting device. In some implementations, the response will include digital signature, the received nonce (without change or changed according to an agreed upon protocol such as incrementing a value), and the UID. In some implementations, only the digital signature may be returned to reduce complexity.

FIG. 6 is a block diagram illustrating a computing system according to some embodiments of the disclosure.

As illustrated in FIG. 6, a computing system 600 includes a host processor 602 communicatively coupled to a memory system 604 via a bus 616. The memory system 604 comprises a controller 606 communicatively coupled to one or more memory banks (e.g., banks 614A-614N, etc.) forming a memory array via an interface 618. As illustrated, the controller 606 include a local cache 608, firmware 610, and an ECC 612.

In the illustrated embodiment, host processor 602 can comprise any type of computer processor, such as a central processing unit (CPU), graphics processing unit (GPU), or other types of general-purpose or special-purpose computing devices. The host processor 602 includes one or more output ports that allow for the transmission of address, user, and control data between the host processor 602 and the memory system 604. In the illustrated embodiment, this communication is performed over the bus 616. In one embodiment, the bus 616 comprises an input/output (I/O) bus or a similar type of bus.

The memory system 604 is responsible for managing one or more memory banks (e.g., banks 614A-614N, etc.). In one embodiment, the memory banks (e.g., banks 614A-614N, etc.) comprise NAND Flash dies or other configurations of non-volatile memory. In one embodiment, the memory banks (e.g., banks 614A-614N, etc.) comprise a memory array.

The memory banks (e.g., banks 614A-614N, etc.) are managed by the controller 606. In some embodiments, the controller 606 comprises a computing device configured to mediate access to and from banks (e.g., banks 614A-614N, etc.). In one embodiment, the controller 606 comprises an ASIC or other circuitry installed on a printed circuit board housing the memory banks (e.g., banks 614A-614N, etc.). In some embodiments, the controller 606 may be physically separate from the memory banks (e.g., banks 614A-614N, etc.). The controller 606 communicates with the memory banks (e.g., banks 614A-614N, etc.) over the interface 618. In some embodiments, this interface 618 comprises a physically wired (e.g., traced) interface. In other embodiments, the interface 618 comprises a standard bus for communicating with memory banks (e.g., banks 614A-614N, etc.).

The controller 606 comprises various modules including local cache 608, firmware 610 and ECC 612. In one embodiment, the various modules (e.g., local cache 608, firmware 610 and ECC 612) comprise various physically distinct modules or circuits. In other embodiments, the modules (e.g., local cache 608, firmware 610 and ECC 612) may completely (or partially) be implemented in software or firmware.

As illustrated, firmware 610 comprises the core of the controller and manages all operations of the controller 606. The firmware 610 may implement some or all of the methods described above. Specifically, the firmware 610 may implement the methods described in the foregoing figures.

FIG. 7 is a block diagram of a computing device according to some embodiments of the disclosure.

As illustrated, the device 700 includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 702 may comprise a general-purpose CPU. The CPU 702 may comprise a single-core or multiple-core CPU. The CPU 702 may comprise a system-on-a-chip (SoC) or a similar embedded system. In some embodiments, a graphics processing unit (GPU) may be used in place of, or in combination with, a CPU 702. Memory 704 may comprise a memory system including a dynamic random-access memory (DRAM), static random-access memory (SRAM), Flash (e.g., NAND Flash), or combinations thereof. In one embodiment, the bus 714 may comprise a Peripheral Component Interconnect Express (PCIe) bus. In some embodiments, the bus 714 may comprise multiple busses instead of a single bus.

Memory 704 illustrates an example of a non-transitory computer storage media for the storage of information such as computer-readable instructions, data structures, program modules, or other data. Memory 704 can store a basic input/output system (BIOS) in read-only memory (ROM), such as ROM 708 for controlling the low-level operation of the device. The memory can also store an operating system in random-access memory (RAM) for controlling the operation of the device.

Applications 710 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 707 by CPU 702. CPU 702 may then read the software or data from RAM 707, process them, and store them in RAM 707 again.

The device may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth®, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 7, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

These computer program instructions can be provided to a processor of a general purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure a computer readable medium (or computer-readable storage medium) stores computer data, which data can include computer program code or instructions that are executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A system comprising:
a computing device; and
a key management server (KMS) configured to:
write a public key to the computing device using a first command signed by a remote KMS, and
write a public key of a second computing device to the computing device using a second command signed using an LKMS private key.

2. The system of claim 1, wherein the KMS is further configured to request a command from the remote KMS and receive the first command from the KMS.

3. The system of claim 2, wherein the computing device is configured to receive the first command and validate the first command by validating a digital signature using a public key of the remote KMS.

4. The system of claim 3, wherein the computing device replaces the public key of the remote KMS with a public key of the KMS if the digital signature is valid.

5. The system of claim 1, wherein the KMS is configured to receive the public key of the second computing device, confirm an identity of the second computing device, and transmit the second command to the computing device, the second command including the public key of the second computing device.

6. The system of claim 5, wherein the computing device is configured to validate the second command by validating a digital signature using the public key of the KMS.

7. The system of claim 1, wherein the computing device is further configured to transmit a nonce to the second computing device, receive a response including a digital signature generated by the second computing device, validate the digital signature generated by the second computing device using the public key of the second computing device, and initiate communications with the second computing device when the digital signature is valid.

8. The system of claim 7, wherein the second computing device is configured to receive the nonce and generate the digital signature by signing the nonce and a unique identifier (UID) of the second computing device using a private key of the second computing device, the private key corresponding to the public key of the second computing device stored by the computing device.

9. A method comprising:
receiving, by a computing device, a first public key from a local key management server (LKMS);
receiving, by the computing device, a signed command that includes a second public key associated with a second computing device;
validating, by the computing device, the signed command using the first public key; and
writing the second public key to a secure storage area of the computing device.

10. The method of claim 9, wherein receiving the first public key comprises receiving a second signed command, the second signed command signed using a key management server (KMS) private key.

11. The method of claim 10, further comprising validating the second signed command using an KMS public key corresponding to the KMS private key and replacing the KMS public key with the first public key.

12. The method of claim 9, wherein receiving the signed command comprises receiving the second public key and a digital signature and wherein validating the signed command comprises validating the digital signature using the first public key.

13. The method of claim 9, further comprising generating a nonce and transmitting the nonce to the second computing device before initiating a connection to the second computing device.

14. The method of claim 13, further comprising receiving a response to the nonce, the response including a second digital signature and validating the second digital signature using the second public key before initiating a connection to the second computing device.

15. A method comprising:
transmitting, by a first computing device, a nonce to a second computing device;
receiving, by the first computing device, a response including a digital signature generated using the nonce;
reading, by the first computing device, a public key associated with the second computing device; and
validating, by the first computing device, the second computing device by validating the digital signature using the public key.

16. The method of claim 15, wherein generating nonce comprises generating a random or pseudo-random value.

17. The method of claim 15, further comprising transmitting data to the second computing device after validating the second computing device.

18. The method of claim 15, wherein the response further includes a received nonce and validating the second computing device further comprises comparing the received nonce to the nonce.

19. The method of claim 15, wherein the response further includes a unique identifier (UID) of the second computing device and validating the second computing device further comprises comparing the UID to a local UID mapped to the public key.

20. The method of claim 15, wherein reading the public key comprises reading the public key from a secure storage area of a secure element.
